(19) United States
(12) Patent Application Publication
(10) Pub. No.: US 2004/0185897 A1
(43) Pub. Date: Sep. 23, 2004

(54) Portable radio communication device and an antenna arrangement for a portable radio communication device

(76) Inventor: Torsten Ostervall, Stockholm (SE)

Correspondence Address: HOLLAND & HART, LLP, 555 17TH STREET, SUITE 3200, DENVER, CO, 80201, US

(21) Appl. No.: 10/479,752

(22) PCT Filed: May 31, 2002
(86) PCT No.: PCT/SE02/01041

(30) Foreign Application Priority Data
Jun. 8, 2001 (SE) 0102031-2

(51) Int. Cl. H04M 1/00

(52) U.S. Cl. 455/550.1; 455/575.1

(57) ABSTRACT

device comprising a first planar dielectric substrate provided with electric circuitry (1); an antenna arrangement, including an antenna element (2, 2′) and a second planar dielectric substrate different from said first planar dielectric substrate and provided with electric circuitry (3), wherein the electric circuitry of said second planar dielectric substrate is connected to the electric circuitry of said first planar dielectric substrate and to said antenna element; at least one power amplifier for amplification of RF signals to be transmitted via said antenna element; and a power supply connector connected to a power supply (4) for supplying said power amplifier with DC power; wherein said at least one power amplifier and said power supply connector are arranged on said second planar dielectric substrate and connected to the electric circuitry of said second planar dielectric circuitry.

### FIELD OF INVENTION

The present invention relates generally to portable radio communication devices.

### BACKGROUND

In radio communication systems of today there is an ever increasing demand for making the user devices smaller. This is especially true when it comes to portable radio communication devices, such as mobile telephones. The design of mobile telephones must permit them to be easily and rapidly manufactured at low costs. However, the mobile telephones must still be reliable in use and exhibit good performance.

The increasing demand puts requirements e.g. on the antenna arrangement of a mobile telephone to be compact, versatile and to have good antenna performance. It must also be robust, stable, easy to mount, easy to connect, and arranged so as to efficiently use the available space. The requirements are particularly high when mounting an antenna arrangement inside the housing of a mobile telephone to avoid protruding antenna parts.

The radiating properties of an antenna arrangement for a small-sized structure, such as a mobile telephone, depend strongly on the shape and size of support structures, such as e.g. a printed circuit board (PCB) of the mobile telephone, or a phone casing. All radiation properties, such as resonance frequency, input impedance, radiation pattern, impedance, polarization, gain, bandwidth, and near-field pattern are affected by the antenna arrangement itself and its interaction with the PCB and the phone casing. On top of this, objects in the close-by environment such as a user affect radiation properties.

What has been stated above is true also with respect to portable radio communication systems used in other apparatuses than mobile telephones, such as cordless telephones, telemetry systems, wireless data terminals, etc. Thus, even if the antenna arrangement of the present invention is described in connection with mobile telephones it is applicable on a broad scale of various portable radio communication apparatuses.

For all types of radio communication devices, the part between the antenna element and the active components of the RF front-end is critical for the total performance of the radio communication device. This is because all losses that occur here are critical from a system point of view. On the receiver side losses that occur before the low noise amplifier (LNA) degrade the sensitivity of the receiver. On the transmitter side, losses that occur after the power amplifier (PA) cause degradation of the transmitted power, forcing the PA to transmit at a higher output level.

These factors are even more critical for mobile telephones as they experience various signal conditions and are battery powered. Reduced receiver sensitivity causes the device to perform worse in areas with low signal levels. A higher output level from the PA increases the energy consumption from the battery, thereby reducing the available operation time.

Resistive losses can be substantially reduced by shortening the connection lines between the antenna element and the required active components. This can be obtained by mounting the components close to the antenna element, and preferably on a common support structure from the components in order to form a separate antenna module.

### SUMMARY OF THE INVENTION

An object of the present invention is to provide a portable radio communication device and an antenna arrangement for a portable radio communication device that reduces the influence of the head of a user close to the portable radio communication device.

Another object of the present invention is to provide a portable radio communication device and an antenna arrangement for a portable radio communication device that utilize available space efficiently.

These objects, among others, are according to the present invention attained by devices and arrangements, respectively, as defined in the appended claims.

By providing a power amplifier (PA) and a power supply connector on an antenna PCB a shortened current path from the power supply connector to the PA and subsequently on to the radiating element is achieved. The current to the PA and subsequently on to the radiating element is one of the highest DC currents in a portable radio communication device. Since the current path of one of the highest currents in the portable radio communication device is shortened resistive losses are kept to a minimum.

By removing the need of a power amplifier and a power supply connector from a main PCB of a portable radio communication device to an antenna PCB an increased distance to the head of a user close to the portable radio communication device is achieved. Since one of the highest DC currents is moved away from the head of a user close to the portable radio communication device reduced influence between the head of the user and that DC current is obtained.

By providing an antenna PCB essentially perpendicular to a main PCB in a portable radio communication device efficient utilization of the available space is achieved.

Further features and advantages of the present invention will be evident from the following description of embodiments.

### BRIEF DESCRIPTION OF THE DRAWINGS

The present invention will become better understood from the detailed description of embodiments given below and the accompanying figures, which are given by way of illustration only, and thus, are not limitative of the present invention, wherein:

FIG. 1 shows a perspective view of a stripped-down portable radio communication device according to a first embodiment of the present invention;

FIG. 2 shows a side view of a stripped-down portable radio communication device according to a second embodiment of the present invention;

FIG. 3 shows a side view of a stripped-down portable radio communication device according to a third embodiment of the present invention;

FIG. 4 shows a side view of a stripped-down portable radio communication device according to a fourth embodiment of the present invention; and

FIG. 5 shows a side view of a stripped-down mobile telephone according to a general aspect of the present invention and a side view of a stripped-down prior art mobile telephone.

### DETAILED DESCRIPTION OF EMBODIMENTS

In the following description, for purpose of explanation and not limitation, specific details are set forth, such as particular techniques and applications in order to provide a thorough understanding of the present invention. However, it will be apparent for a person skilled in the art that the present invention may be practiced in other embodiments that depart from these specific details. In other instances, detailed description of well-known methods and apparatuses are omitted so as not to obscure the description of the present invention with unnecessary details.

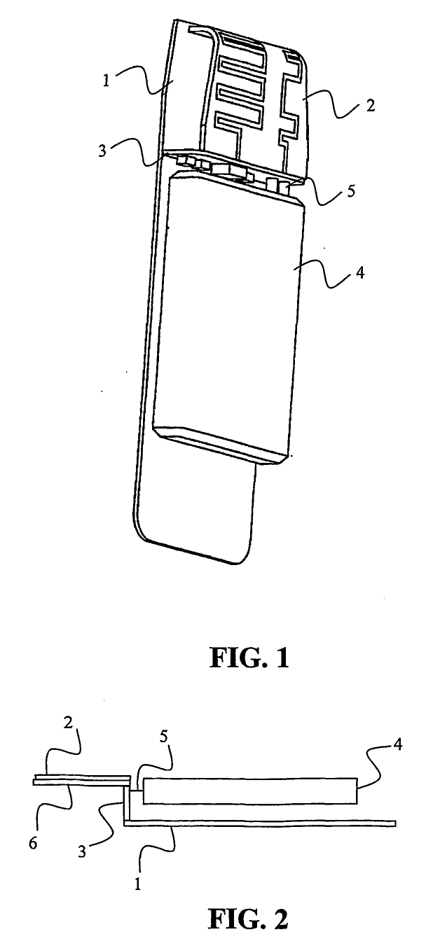

A first embodiment of the present invention will now be described with reference to FIG. 1.

A portable radio communication device, such as a mobile telephone, comprises a planar dielectric substrate provided with electric main circuitry, such as a main printed circuit board (PCB) 1 provided with components for operation of the telephone; an antenna element 2 including radiating elements; a planar dielectric substrate provide with electrical antenna circuitry, such as an antenna PCB 3 provided with components for operation of the antenna element; and a power supply 4, such as a battery.

The antenna PCB 3 is attached essentially perpendicular to the main PCB 1 by means of a connector, which orientation provides efficient utilization of space in the mobile telephone. The antenna PCB 3 may alternatively be arranged parallel to the main PCB 1 or inclined in various angles thereto. The antenna PCB 3 is provided with a power supply connector 5 connecting the battery 4 to the antenna PCB 3, which battery 4 supplies DC power to the electric circuitry of the mobile telephone. The antenna connector connects the battery 4 directly to the antenna PCB 3, i.e. the antenna PCB 3 is arranged close to the battery 4. An alternative to a connector between the antenna PCB 3 and the main PCB 1 is to integrate the top-layer flex-film of the two PCB.

Two power amplifiers (PA) are arranged on the antenna PCB 3, one for each radiating element. A PA is one of the highest power-consuming components of the mobile telephone. By providing the PAs and the power supply connector 5 on the antenna PCB 3 the current path for the DC power from the battery 4 to the PAs and subsequently to the antenna element 2 is reduced to a minimum.

A further advantage with a PA on an antenna PCB is that the increased amount of air around the PA gives the possibility to better cooling of the PA.

The antenna element 2 has two radiating elements and is attached to the antenna PCB 3. As the antenna element 2 is close to the PAs on the antenna PCB 3 a low power loss between the PAs and the radiating element is obtained. The antenna element 2 is illustrated with two radiating elements but may have more or fewer radiating elements. The number of PAs is matched to the number of radiating elements.

The battery 4 is easily detachable for recharging or for replacement. Alternatively, a battery need not be detached for recharging, but may be recharged while attached to the mobile telephone. A rechargeable battery usually includes circuitry for controlling a recharge process, e.g. such that the battery is not overcharged. Such circuitry can be provided on the antenna PCB instead, allowing the battery to only comprise DC connectors and battery cells.

As rechargeable batteries of today are almost as long-lived as the rest of the mobile telephone it is not necessary to provide a replaceable battery, but a permanently attached battery would be sufficient, which facilitates the design of the mobile telephone.

The PAs are only one kind of component that needs DC power in the mobile telephone and in order to provide DC power to the main PCB 1 a board connector on the antenna PCB 3 relays DC power from the antenna PCB 3 to the main PCB 1.

The antenna PCB 3 may be provided with further electric circuitry for antenna operation. Two low noise amplifiers (LNA) for amplification of received RF signals are advantageously provided close to the antenna element, i.e. on the antenna PCB 3. Further circuitry may e.g. include filters, frequency up/down converters, and switches. By providing all RF circuitry for antenna operation on the antenna PCB 3 a preferred antenna module is formed, since a natural interface is obtained between the antenna PCB 3 and the main PCB 1.

A low-resistance connection has a higher loss than a 50Ω connection. By providing a PA and/or an LNA on an antenna PCB close to an antenna element it is feasible and advantageous to use non-50Ω connections between the PA and the antenna element and/or between the LNA and the antenna element, as the higher resistance losses as very small.

A second embodiment of the present invention will next be described with reference to FIG. 2.

A mobile telephone comprises a planar dielectric substrate provided with electric main circuitry, such as a main PCB 1 provided with components for operation of the mobile telephone; an antenna element 2; a planar dielectric substrate provided with electrical antenna circuitry, such as an antenna PCB 3 provided with components for antenna operation, wherein the antenna PCB 3 is connected to the antenna element 2; a support structure 6 supporting the antenna element 3; and a battery 4.

The antenna element 2 may be a flex film, wherein conductive portions forms radiating elements, integrated with the flex-film of the antenna PCB 3, but not supported by the antenna PCB 3. The support structure 6 for the antenna element 2 may be comprised of a framework supporting the edges of the antenna element 2, or only the edge of the antenna element 2 farthest from the antenna PCB 3. The flex-film may be supported by a planar circuit board, but advantageously the antenna element 2 is formed to fit the design of the mobile telephone supported by the framework 6.

The antenna PCB 3 is provided with a power supply connector 5 connected to the battery 4 for DC power supply, and a board connector for attachment of the antenna PCB 3 essentially perpendicular to the main PCB 1. The antenna PCB 3 is further provided with a PA for amplification of RF signals to be transmitted by the antenna element 2.

The antenna PCB 3 may further be provided with circuitry, for antenna operation, such as e.g. an LNA, such that an antenna arrangement can be provided as a preferred antenna module as described in the first embodiment. The antenna PCB 3 may also be provided with circuitry for battery operation, such that a battery for use with the mobile telephone only needs DC connectors and battery cells.

The main PCB 1 and the antenna PCB 3 need not be separated PCBs but may be comprised of an integrated PCB, i.e. connected substrates with a single flex-film.

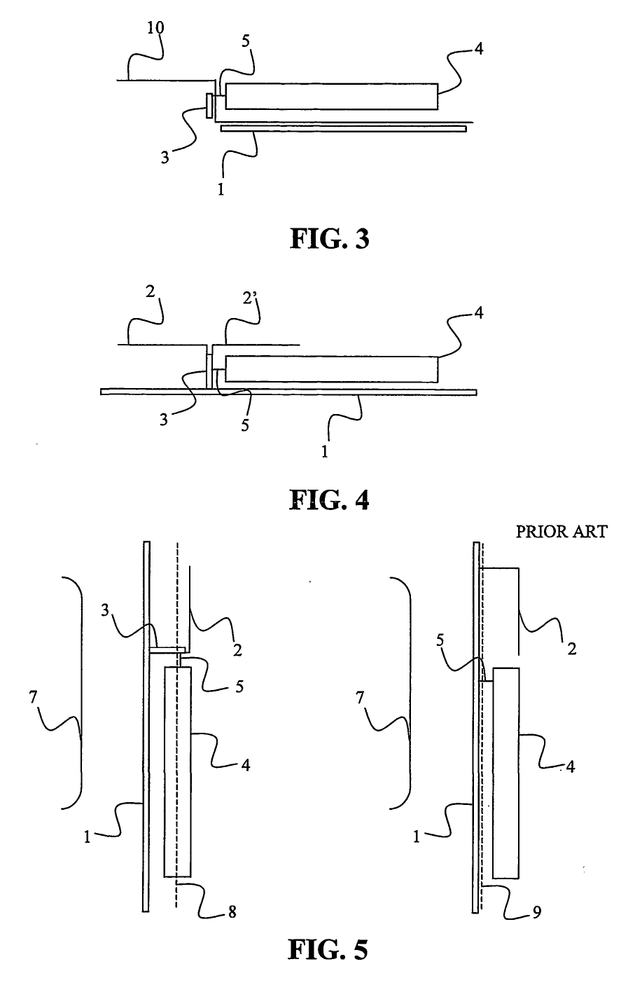

A third embodiment of the present invention will next be described with reference to FIG. 3.

This embodiment is identical with the second embodiment except that the top layer of the main PCB 1, the antenna element, and the top layer of the antenna PCB 3 is a single flex-film 10. With the flex-film 10 no connectors are needed between the antenna element and the antenna PCB 3, and/or between the antenna PCB 3 and the main PCB 1.

The single flex-film 10 is supported by the antenna PCB 3, the main PCB 1, and by a support structure for the antenna element. The stiff part of the antenna PCB 3 supports the top layer of the antenna PCB, which is one part of the single flex-film 10. The stiff part of the main PCB 1 supports the top layer of the main PCB, which is a second part of the single flex-film 10. A support structure (not shown in FIG. 3) supports the antenna element, which is a third part of the single flex-film 10.

A fourth embodiment of the present invention will next be described with reference to FIG. 4.

A mobile telephone comprises a main PCB 1; two antenna elements 2 and 2′; an antenna PCB 3 connected to the antenna elements 2 and 2′; and a battery 4.

The antenna PCB 3 is provided with a power supply connector 5 connected to the battery 4 for supplying DC power, and a board connector for attachment of the antenna PCB 3 essentially perpendicular to the main PCB 1. The antenna PCB 3 is further provided with a PA for amplification of RF signals to be transmitted by the antenna elements 2 and 2′. The PA has a balanced output, which allows easy feeding of the two similar antenna elements 2 and 2′.

The antenna PCB 3 may further be provided with circuitry, for antenna operation, such as e.g. an LNA, such that an antenna arrangement can be provided as a practical antenna module. The antenna PCB 3 may also be provided with circuitry for battery operation, such that a battery for use with the mobile telephone only needs DC connectors 5 and battery cells.

A general aspect of the present invention will next be described with reference to FIG. 5.

A mobile telephone according to the present invention and the head of a user 7 close to the mobile telephone are shown to the left in FIG. 5. The largest DC current of the mobile telephone, i.e. the current fed to the PA and subsequently to the transmitting part of the antenna element 2, is not present closer to the user than indicated by the dashed line 8.

A mobile telephone according to prior art and the head of a user 7 close to the mobile telephone are shown to the right in FIG. 5. The largest DC current of the mobile telephone, i.e. the current fed to the PA and subsequently to the transmitting part of the antenna element 2, is present closer to the user than indicated by the dashed line 9.

The difference in the distance between the head of a user 7 and the dashed lines 8, 9, respectively, is several millimeters. Such distance differences are very significant when dealing with current dependencies in the near-field as even one millimeter is significant. The distance to the head of a user 7 does not affect the far-field and thus the increased distance to the user is very advantageous.

Although the above described antenna arrangements only include internal radiating elements, they may comprise any type of radiating element, such as e.g. a retractable whip, a meander, an inverted F, a helix, etc.

It will be obvious that the present invention may be varied in a plurality of ways. Such variations are not to be regarded as departure from the scope of the present invention. All such variations as would be obvious for a person skilled in the art are intended to be included within the scope of the present invention.

1. A portable radio communication device comprising:
a first planar dielectric substrate provided with electric circuitry (1);
an antenna arrangement, including an antenna element (2, 2′) and a second planar dielectric substrate different from said first planar dielectric substrate and provided with electric circuitry (3), wherein the electric circuitry of said second planar dielectric substrate is connected to the electric circuitry of said first planar dielectric substrate and to said antenna element;
at least one power amplifier for amplification of RF signals to be transmitted via said antenna element; and
a power supply connector connected to a power supply (4) for supplying said power amplifier with DC power;
characterized in that said at least one power amplifier and said power supply connector are arranged on said second planar dielectric substrate and connected to the electric circuitry of said second planar dielectric circuitry and that said first planar dielectric substrate is separate from said first planar dielectric substrate.

2. The portable radio communication device as claimed in claim 1, wherein said first and second planar dielectric substrates are provided as first and second circuit boards.

3. The portable radio communication device as claimed in claim 1, wherein the electric circuitry of said first and second planar dielectric substrates is provided on a single flex-film.

4. The portable radio communication device as claimed in claim 3, wherein said antenna element is provided on said single flex-film.

5. The portable radio communication device as claimed in any of claims 1-4, wherein said second planar dielectric substrate is arranged adjacent said power supply.

6. The portable radio communication device as claimed in any of claims 1, 2 or 5, wherein power supply to the electric circuitry of said first planar dielectric substrate is provided via the electric circuitry of said second planar dielectric substrate.

7. The portable radio communication device as claimed in any of claims 1-6, wherein said second planar dielectric substrate is oriented essentially perpendicular to said first planar dielectric substrate.

8. The portable radio communication device as claimed in any of claims 1-7, wherein said power supply is permanently connected to said power supply connector.

9. The portable radio communication device as claimed in any of claims 1-8, wherein circuitry for battery operation is arranged on said second planar dielectric substrate.

10. The portable radio communication device as claimed in any of claims 1-9, wherein RF circuitry for antenna operation is arranged on said second planar dielectric substrate.

11. An antenna arrangement for a portable radio communication device including a first circuit board (1), comprising:
an antenna element (2, 2′); and
a second circuit board (3) different from said first circuit board and connected to said antenna element and including a connector connectable to said first circuit board;
characterized in that
at least one power amplifier for amplification of RF signals to be transmitted via said antenna element and a power supply connector for supplying said power amplifier with DC power are arranged on said second circuit board.

12. The antenna arrangement as claimed in claim 11, wherein said connector is arranged to connect said second circuit board essentially perpendicular to said first circuit board.

13. The antenna arrangement as claimed in claim 11 or 12, wherein circuitry for battery operation is arranged on said second circuit board.

14. The antenna arrangement as claimed in any of claims 11-13, wherein RF circuitry for antenna operation is arranged on said second circuit board.

15. An antenna and battery arrangement for a portable radio communication device including a first circuit board (1), comprising:
an antenna element (2, 2′); and
a second circuit board (3) different from said first circuit board and connected to said antenna element and including a connector connectable to said first circuit board;
characterized in that
at least one power amplifier for amplification of RF signals to be transmitted via said antenna element and a power supply connector for supplying said at least one power amplifier with DC power are arranged on said second circuit board; and
a power supply (4) is permanently connected to said power supply connector.

16. A portable radio communication device comprising:
a first planar dielectric substrate provided with electric circuitry (1);
an antenna arrangement, including an antenna element (2, 2′) and a second planar dielectric substrate different from said first planar dielectric substrate and provided with electric circuitry (3), wherein the electric circuitry of said second planar dielectric substrate is connected to the electric circuitry of said first planar dielectric substrate and to said antenna element; and
at least one power amplifier for amplification of RF signals to be transmitted via said antenna element;
characterized in that said at least one power amplifier is arranged on said second planar dielectric substrate and connected to the electric circuitry of said second planar dielectric substrate and said second planar dielectric substrate is oriented essentially perpendicular to said first planar dielectric substrate.

17. The portable radio communication device as claimed in claim 16, wherein said first and second planar dielectric substrates are provided as first and second circuit boards.

18. The portable radio communication device as claimed in claim 16, wherein the electric circuitry of said first and second planar dielectric substrates is provided on a single flex-film.

19. The portable radio communication device as claimed in claim 18, wherein said antenna element is provided on said single flex-film.

20. The portable radio communication device as claimed in any of claims 16-19, wherein said second planar dielectric substrate is arranged closer to a power supply for the portable radio communication device than a major part of said antenna element.

21. The portable radio communication device as claimed in any of claims 16-20, wherein said second planar dielectric substrate comprises a power supply connector connected to a power supply for supplying said at least one power amplifier with DC power.
